(19) United States
(12) Patent Application Publication
(10) Pub. No.: US 2026/0175594 A1
(43) Pub. Date: Jun. 25, 2026

(54) RECORDING APPARATUS

(71) Applicant: SEIKO EPSON CORPORATION, Tokyo (JP)

(72) Inventors: Daisuke TANAKA, SHIOJIRI-SHI (JP); Mitsuhiro KOSEKI, CHINO-SHI (JP); Hiroki CHINO, MATSUMOTO-SHI (JP); Masanori NAKATA, MATSUMOTO-SHI (JP)

(21) Appl. No.: 19/426,322

(22) Filed: Dec. 19, 2025

(30) Foreign Application Priority Data
Dec. 25, 2024 (JP) 2024-228420

(51) Int. Cl. B41J 11/00; B41J 29/17

(52) U.S. Cl. CPC B41J 11/0015; B41J 11/0045; B41J 11/007; B41J 29/17

(57) ABSTRACT

A recording apparatus is configured including: a recording unit configured to perform recording by ejecting a liquid onto a recording surface of a medium; a medium support portion configured to support the medium at a position facing the recording unit; and a guide part facing the recording surface of the medium and configured to guide the medium to the medium support portion. The guide part has a conductive region having conductivity.

The present application is based on, and claims priority from JP Application Serial Number 2024-228420, filed December 25, 2024, the disclosure of which is hereby incorporated by reference herein in its entirety.

### BACKGROUND

### 1. TECHNICAL FIELD

The present disclosure relates to a recording apparatus.

### 2. RELATED ART

For example, JP-A-2009-202460 discloses an inkjet recording apparatus provided with a paper dust capturing mechanism in order to restrict adhesion of a foreign matter to an inkjet head. According to JP-A-2009-202460, the paper dust capturing mechanism is provided upstream of the inkjet head, and includes a pair of conveying rollers that convey paper, a sponge member disposed so as to come into contact with an outer peripheral surface of the conveying roller, a box having a paper dust holding portion that holds paper dust removed by the sponge member, an auger member that is rotatably disposed and conveys the paper dust held by the paper dust holding portion, and two paper dust storage portions that are fixed to a side wall of the box and store the paper dust conveyed by the auger member.

JP-A-2009-202460 is an example of the related art.

However, in the inkjet recording apparatus disclosed in JP-A-2009-202460, a dedicated paper dust capturing mechanism for capturing paper dust is required, causing an increase in the number of components and an increase in the size of the recording apparatus.

That is, there is a demand for a recording apparatus capable of restricting adhesion of a foreign matter with a simple configuration.

### SUMMARY

A recording apparatus according to an aspect of the present disclosure is configured including: a recording unit configured to perform recording by ejecting a liquid onto a recording surface of a medium; a medium support portion configured to support the medium at a position facing the recording unit; and a guide part facing the recording surface of the medium and configured to guide the medium to the medium support portion. The guide part has a conductive region having conductivity.

### BRIEF DESCRIPTION OF THE DRAWINGS

FIG. 1 is a schematic configuration diagram of a recording apparatus according to a first embodiment.

FIG. 2 is a schematic configuration diagram of the recording apparatus in which a recording unit is in a standby state.

FIG. 3 is an enlarged cross-sectional view of a periphery of a conveyance belt.

FIG. 4 is an enlarged cross-sectional view of a periphery of a static eliminator unit.

FIG. 5 is a perspective view of the static eliminator unit viewed from the conveyance belt side.

FIG. 6 is a perspective view of a main body viewed from a downstream side.

FIG. 7 is a perspective view of the static eliminator unit viewed from an upstream side.

FIG. 8 is a graph illustrating measurement results about the quantity of adhered paper dust when a guide part is made conductive.

FIG. 9 is a graph illustrating measurement results about paper surface potential when the guide part is made conductive.

FIG. 10 is a perspective view of a guide part according to a second embodiment.

### DESCRIPTION OF EMBODIMENTS

### FIRST EMBODIMENT

### Configuration of Recording Apparatus

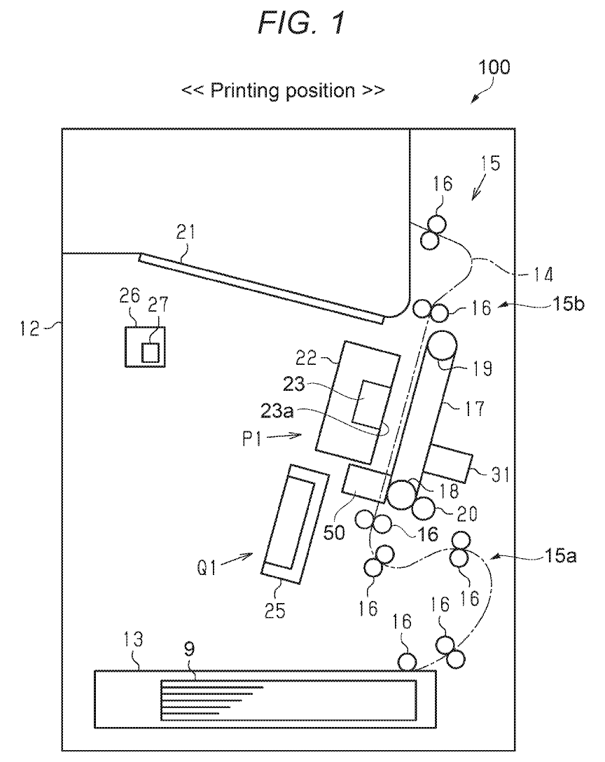

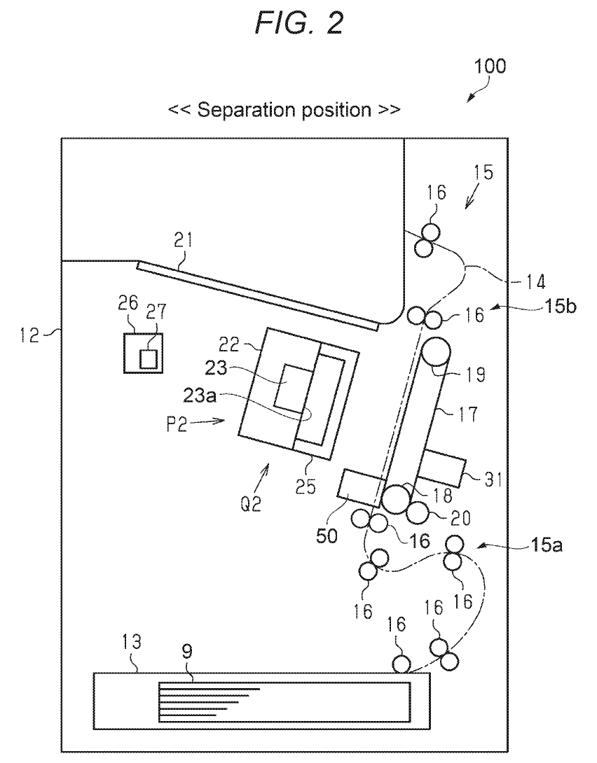

FIG. 1 is a schematic configuration diagram of a recording apparatus according to a first embodiment. FIG. 2 is a schematic configuration diagram of the recording apparatus in which a recording unit is in a standby state.

The embodiment of the present disclosure will be described below with reference to the drawings. The following embodiment describes an example of the present disclosure, and the present disclosure is not limited to the following embodiment, and includes various modifications that can be implemented without changing the gist of the present disclosure. In the drawings below, dimensions and scales different from actual values may be used for clarity of the description.

A recording apparatus 100 illustrated in FIG. 1 is an inkjet printer that records a character or an image such as a photograph by discharging ink, which is an example of a liquid, onto a medium such as paper or fabric.

The recording apparatus 100 includes a housing 12.

The recording apparatus 100 includes an accommodation portion 13. The accommodation portion 13 is configured to accommodate a medium 9. The accommodation portion 13 is a cassette that can be pulled out from the housing 12, and is provided, for example, in a lower portion of the housing 12. The accommodation portion 13 accommodates the plurality of stacked media 9.

The recording apparatus 100 includes a conveyance path 14. The conveyance path 14 is a path through which the medium 9 is conveyed. The conveyance path 14 extends in the housing 12. The conveyance path 14 extends from the accommodation portion 13 to a stacker 21. The stacker 21 is, for example, a discharge tray provided in an upper portion of the housing 12,and is provided such that the plurality of media 9 can be placed thereon. In the conveyance path 14, the accommodation portion 13 side is referred to as an upstream side, and the stacker 21 side is referred to as a downstream side. The medium 9 is described as paper in a preferred example, but is not limited to paper.

The recording apparatus 100 includes a conveyance unit 15. The conveyance unit 15 is configured to convey the medium 9. The conveyance unit 15 conveys the medium 9 from the accommodation portion 13 along the conveyance path 14. The conveyance unit 15 includes, for example, one or more roller pairs 16 and a conveyance belt 17. The plurality of roller pairs 16 are disposed at positions along the conveyance path 14.

The conveyance belt 17 is a medium support portion, and in a preferred example, is an electrostatic attraction belt that attracts and conveys the medium 9 by electrostatic attraction. The conveyance belt 17 is an endless belt, and is suspended by a first pulley 18 on the upstream side and a second pulley 19 on the downstream side so as to be rotatable clockwise. In one example, the conveyance belt 17 supports the medium 9 in a posture inclined with respect to a horizontal direction, and conveys the medium 9 obliquely upward by electrostatic attraction without dropping the medium 9. The conveyance unit 15 upstream of the conveyance belt 17 is referred to as an upstream conveyance unit 15a, and the conveyance unit 15 downstream of the conveyance belt 17 is referred to as a downstream conveyance unit 15b.

The recording apparatus 100 includes a recording unit 22 disposed at a position facing the conveyance belt 17. The recording unit 22 includes a print head 23 that performs printing on the medium 9. The print head 23 is an inkjet type ejection head. In a preferred example, a piezoelectric type is adopted in which a part of a wall surface in a pressure chamber communicating with a nozzle is provided to be deformable, a drive signal is applied to a piezoelectric element to contract the piezoelectric element, the wall surface is bent by the contraction, and ink in the pressure chamber is ejected from the nozzle as an ink droplet. The print head is not limited to the piezoelectric type, and is sufficient to be an inkjet type. For example, a thermal type may be adopted in which a liquid filled in a pressure chamber is heated by causing a current to flow through a resistance element such as a heater, and the thermal energy is transferred to the liquid to eject the liquid.

In a preferred example, the print head 23 has a line head configuration capable of ejecting a liquid over the entire width of the conveyance belt 17 in the width direction thereof. In other words, the recording unit 22 is a line head capable of ejecting the liquid over the entire width of the medium 9 in its width direction intersecting a conveyance direction of the medium 9. Printing on the medium 9 by the print head 23 is also referred to as recording an image on the medium 9. In other words, the recording apparatus 100 includes the recording unit 22 that performs recording by ejecting a liquid onto a recording surface of the medium 9, and the conveyance belt 17 serving as a medium support portion that supports the medium 9 at a position facing the recording unit 22.

A surface of the print head 23 on which a plurality of nozzle openings are provided is referred to as a nozzle surface 23a. The nozzle surface 23a faces the medium 9 placed on the conveyance belt 17 during printing.

The print head 23 is not limited to a line head, and is sufficient to include an ejection head. For example, the print head 23 may be a carriage type print head that performs printing by scanning the conveyance belt 17 in the width direction for a plurality of times.

As illustrated in FIGS. 1 and 2, the recording unit 22 is configured to be movable between a recording position P1 and a separation position P2.

The recording position P1 is a printing position at which the recording unit 22 is close to the conveyance belt 17. The separation position P2 is a standby position where the recording unit 22 is separated from the conveyance belt 17. A distance between the recording unit 22 located at the separation position P2 and the conveyance belt 17 is larger than a distance between the recording unit 22 located at the recording position P1 and the conveyance belt 17. The recording unit 22 is located at the separation position P2 when standing by.

The recording unit 22 is configured to be movable in a direction perpendicular to the nozzle surface 23a. The recording unit 22 is displaced between the recording position P1 and the separation position P2 by moving in the direction perpendicular to the nozzle surface 23a.

The recording apparatus 100 may include a cap 25. The cap 25 is configured to contact the recording unit 22. Specifically, the cap 25 caps the recording unit 22 located at the separation position P2. Capping is to cover the nozzle openings of the print head 23 by the cap 25 contacting the recording unit 22. In one example, the cap 25 caps the recording unit 22 by coming into contact with the nozzle surface 23a. The capping reduces the possibility that the nozzle openings of the print head 23 are dried.

The cap 25 is configured to move between a standby position Q1 and a capping position Q2. The standby position Q1 is a position where the cap 25 stands by. The cap 25 is located at the standby position Q1 when the recording unit 22 is located at the recording position P1. The capping position Q2 is a position between the recording unit 22 and the conveyance belt 17. The cap 25 is located at the capping position Q2 when the recording unit 22 is located at the separation position P2. The recording unit 22 is capped by the cap 25 when the recording unit 22 is located at the separation position P2.

The recording apparatus 100 includes a control unit 26. The control unit 26 comprehensively controls the recording apparatus 100. The control unit 26 may include one or more processors that execute various types of processing according to a computer program. The control unit 26 may include one or more dedicated hardware circuits such as an ASIC that executes at least some of the various types of processing. The control unit 26 may include a circuit including a combination of a processor and a hardware circuit. The processor includes a CPU and a memory such as a RAM and a ROM. The memory stores program codes or commands configured to cause the CPU to execute processing. The memory, that is, a computer-readable medium includes all readable media that can be accessed by a general-purpose or dedicated computer.

The control unit 26 includes a counting unit 27. The counting unit 27 is configured to count the number of conveyed media 9. The counting unit 27 counts the number of media 9 conveyed by the conveyance belt 17. In one example, the counting unit 27 functions as the counting unit 27 when the control unit 26 executes a measurement program. Specifically, the control unit 26 counts the number of conveyed media 9 based on detection data from a first detection unit 55 and a second detection unit 56 as detection units.

### Flow of Printing on Medium

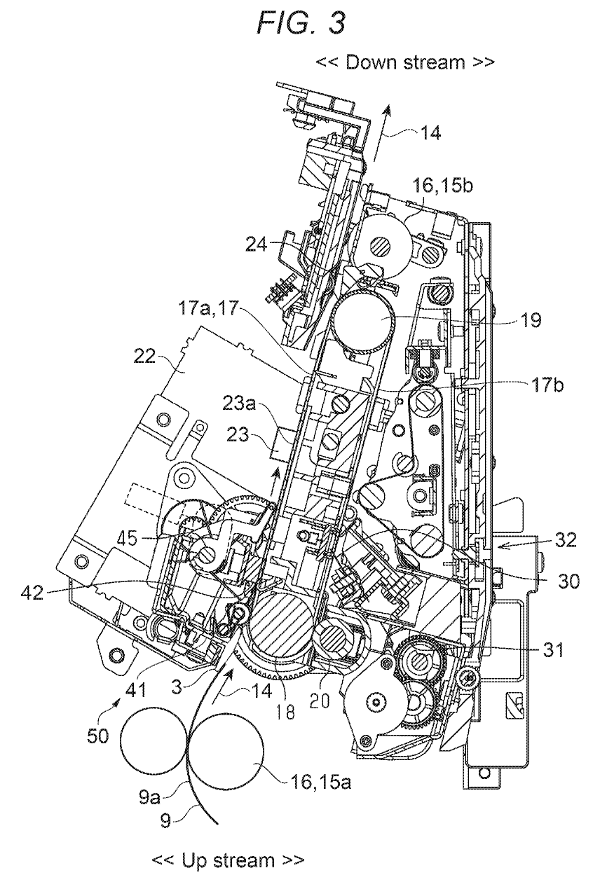

FIG. 3 is an enlarged cross-sectional view of a periphery of the conveyance belt.

Here, a flow of printing on the medium 9 in the recording apparatus 100 will be described.

As illustrated in FIG. 3, a static eliminator unit 50 is provided upstream of the conveyance belt 17 so as to face a conveyance face 17a. The static eliminator unit 50 includes a main body 41 that is a housing, and a static eliminator brush 42 is provided inside the main body 41.

A guide part 3 that guides the medium 9 conveyed from the roller pair 16 of the upstream conveyance unit 15a to the conveyance face 17a of the conveyance belt 17 is provided upstream of the main body 41. The guide part 3 is a part of the main body 41, and is integrally formed with the main body 41 by injection molding in a preferred example. As illustrated in FIG. 3, the medium 9 is conveyed toward the guide part 3 in a curved shape with a recording surface 9a thereof being convex. In other words, the upstream conveyance unit 15a conveys the medium 9 in a curved shape with the recording surface 9a being convex.

The medium 9 guided by the conveyance face 17a of the conveyance belt 17 is conveyed to a position facing the recording unit 22 while being attracted to the conveyance face 17a, and printing is performed on the recording surface 9a that is a front surface thereof.

The printed medium 9 is conveyed downstream, peeled from the conveyance face 17a by a peeling unit 24 including a scraper, and conveyed by the roller pair 16 of the downstream conveyance unit 15b.

After the conveyance belt 17 feeds the medium 9 to the downstream conveyance unit 15b, the conveyance belt 17 turns around by the second pulley 19 and moves at a back face 17b, and foreign matters such as paper dust and powder dust adhered to the surface are removed by a blade 30 of a cleaning unit 32 during the movement. The removed foreign matter is stored in a cleaning box 31 of the cleaning unit 32.

The cleaned conveyance belt 17 is sent to the conveyance face 17a after being nipped between the first pulley 18 and a charging roller 20. The charging roller 20 is a charging unit and charges the surface of the conveyance belt 17 while rotating.

The units including the conveyance belt 17 and the static eliminator unit 50 are supported or fixed by a support frame (not illustrated) provided in the housing 12 (FIG. 1) of the recording apparatus 100. The support frame is grounded to a GND potential.

As illustrated in FIG. 3, the guide part 3 and the recording unit 22 are disposed along the conveyance face 17a of the conveyance belt 17. In other words, the guide part 3 overlaps the recording unit 22 that performs recording on the recording surface 9a when viewed in the conveyance direction of the medium 9.

### Configuration of Static Eliminator Unit

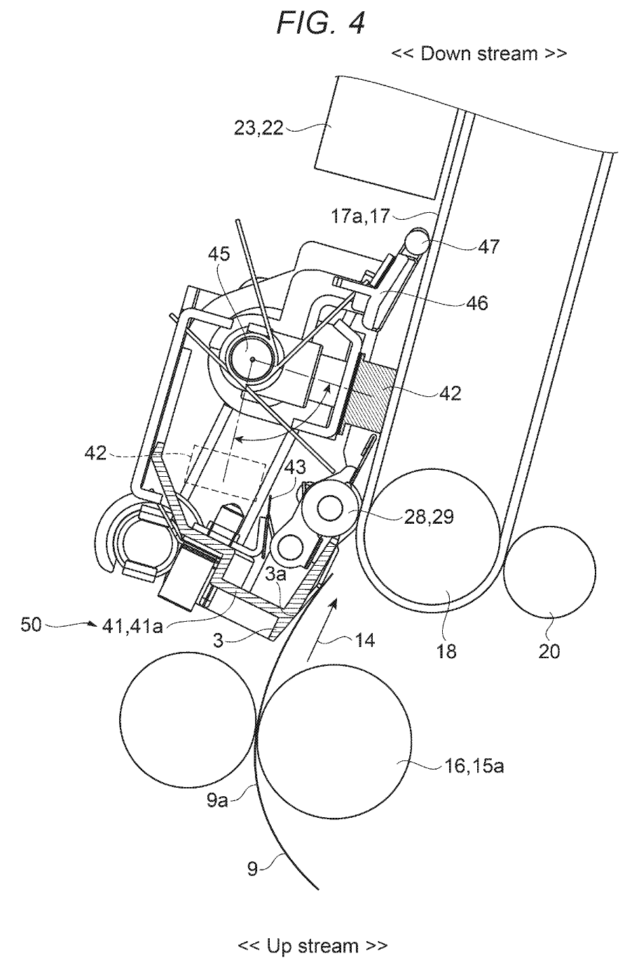

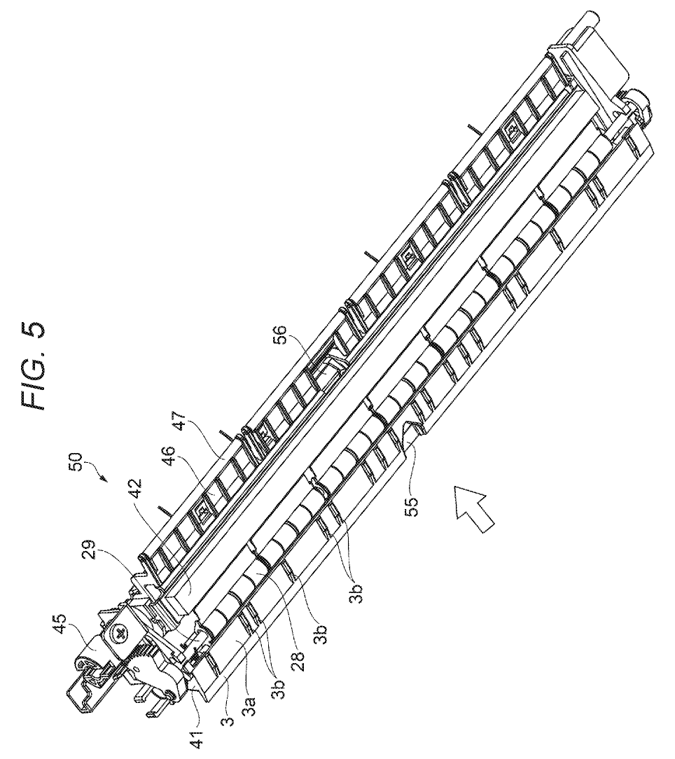

FIG. 4 is an enlarged cross-sectional view of a periphery of the static eliminator unit and corresponds to FIG. 3. FIG. 5 is a perspective view of the static eliminator unit viewed from the conveyance belt side, and the conveyance direction is indicated by an outlined arrow.

As illustrated in FIG. 4, the static eliminator unit 50 includes the guide part 3, a following roller 28, the static eliminator brush 42, and a pressing roller 47 from the upstream side. These portions are assembled to the main body 41.

As illustrated in FIG. 5, the guide part 3 has a large curved surface convex toward the medium 9, and has a shape that easily guides the medium 9 to the conveyance belt 17 along the curved surface.

A face of the guide part 3 on the medium 9 side is referred to as a conveyance face 3a. The conveyance face 3a is provided with a plurality of protrusions 3b extending along the conveyance direction. Each of the protrusions 3b is a guide rib that comes into contact with the medium 9. Since contact area between the guide part 3 and the medium 9 is reduced by providing the protrusions 3b, a sliding load on the medium 9 can be reduced. In other words, the guide part 3 includes the conveyance face 3a facing the medium 9 and protrusions 3b protruding from the conveyance face 3a toward the medium 9. The guide part 3 is a part of the main body 41, and as illustrated in FIG. 4, a side wall 41a of the main body 41 rises in a direction intersecting the conveyance direction from the middle of the guide part 3. A storage corner is formed inside the main body 41 by the side wall 41a of the main body 41 and a downstream portion of the guide part 3. The downstream portion of the guide part 3 overlaps the conveyance belt 17. In other words, the guide part 3 faces the conveyance belt 17.

A cleaning blade 43 as a cleaning portion is attached to the inner side of the side wall 41a, and is provided so as to be able to remove a foreign matter such as paper dust adhered to the static eliminator brush 42. The foreign matter removed by the cleaning blade 43 is stored in the storage corner in the main body 41.

The following roller 28 is a roller paired with the first pulley 18, and nips the medium 9 therebetween to bring the medium 9 into close contact with the conveyance face 17a of the conveyance belt 17, and conveys the medium 9 downstream by rotation. The following roller 28 rotates about a rotation shaft 29.

The static eliminator brush 42 is provided such that a brush at a tip comes into contact with the medium 9, and performs static elimination on the recording surface 9a of the medium 9. In a preferred example, the brush at the tip is made of conductive resin fibers. The present disclosure is not limited thereto, and any brush-like member having the same conductivity may be used. The brush at the tip is electrically coupled to a rotation shaft 45 via a support portion. The rotation shaft 45 is electrically coupled to the support frame grounded to the GND potential (not illustrated) in the housing 12.

As illustrated in FIG. 4, the static eliminator brush 42 is provided so as to be displaceable around the rotation shaft 45 between a static elimination position and a retracted position indicated by a broken line. The static elimination position is a position where the tip brush of the static eliminator brush 42 comes into contact with the medium 9. The retracted position is a position where the tip brush of the static eliminator brush 42 faces the side wall 41a of the main body 41.

When the tip brush of the static eliminator brush 42 is displaced from the static elimination position to the retracted position, the tip brush comes into contact with the cleaning blade 43 to remove a foreign matter such as paper dust. In other words, the static eliminator brush 42 as the static eliminator portion is displaceable between the static elimination position where static electricity is eliminated from the recording surface 9a of the medium 9 and the retracted position where the static eliminator brush 42 is retracted from the static elimination position, and the static eliminator unit 50 includes the cleaning blade 43 as a cleaning portion that cleans the static eliminator brush 42 at the time of displacement.

The pressing roller 47 is a roller that presses the medium 9, which is subjected to static elimination, before printing. The pressing roller 47 is rotatably supported by a rear guide plate 46.

In other words, the recording apparatus 100 includes the static eliminator unit 50 including the static eliminator brush 42 as a static eliminator portion that performs static elimination on the recording surface 9a of the medium 9 supported by the conveyance belt 17. The guide part 3 is provided integrally with the static eliminator unit 50, and at least a part of the conveyance face 3a as a conductive region is located upstream of the static eliminator brush 42 in the conveyance direction of the medium 9.

As illustrated in FIG. 5, the first detection unit 55 is provided in the middle of the guide part 3 in a width direction thereof. The first detection unit 55 is a reflective photosensor in which a light emitting element and a light receiving element are built and digitally detects the presence or absence of the medium 9 by reflected light from a detection object. Since a portion facing the first detection unit 55 is a space without the conveyance belt 17, when the medium 9 is not present, there is little or no reflected light. Detection data from the first detection unit 55 is transmitted to the control unit 26 (FIG. 1) with which the presence or absence of the medium 9 can be detected.

The second detection unit 56 is provided in the middle of the rear guide plate 46 in a width direction thereof. The second detection unit 56 is a reflective photosensor in which a light emitting element and a light receiving element are built and performs analog detection of the presence or absence and a state of the medium 9 by reflected light from the detection object. Since the conveyance belt 17 is at a portion facing the second detection unit 56, light is emitted to the belt surface, and the presence or absence and the state of the medium 9 can be detected based on the intensity of the reflected light. Detection data from the second detection unit 56 is transmitted to the control unit 26 (FIG. 1) with which the presence or absence and a state such as a jam of the medium 9 can be detected. In other words, the static eliminator unit 50 holds the first detection unit 55 and the second detection unit 56 as detection units that detect the medium 9.

### Configuration of Guide part

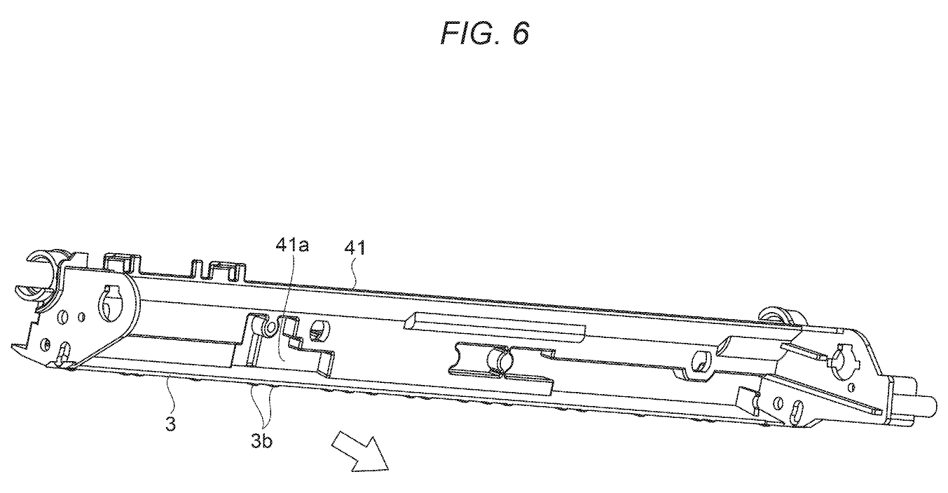

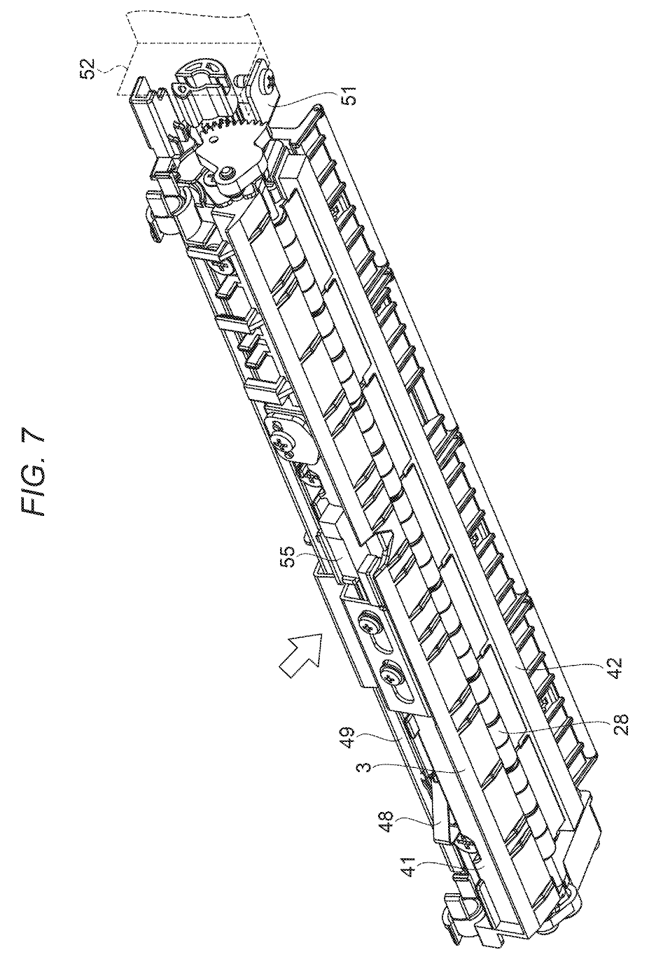

FIG. 6 is a perspective view of the main body viewed from the downstream side. FIG. 7 is a perspective view of the static eliminator unit viewed from the upstream side, and the conveyance direction is indicated by an outlined arrow.

The main body 41 including the guide part 3 is made of a conductive resin. In a preferred example, the main body 41 is formed by injection molding a plastic material obtained by kneading an inorganic conductor such as metal or carbon fiber into an ABS resin. The material is not limited to the ABS resin, and may be a conductive material obtained by kneading an inorganic conductor into a resin material having equivalent physical properties. In other words, the guide part 3 has the conveyance face 3a as a conductive region having conductivity.

FIG. 6 is a perspective view of the main body 41 as a single component viewed from the downstream side, and the conveyance direction is indicated by an outlined arrow. As illustrated in FIG. 6, the guide part 3 is integrally formed with the main body 41 and extends in the conveyance direction intersecting the side wall 41a. Further, the guide part 3 and the side wall 41a form a storage corner for foreign matters.

As illustrated in FIG. 7, a plate-shaped frame member 49 is provided on the opposite side of the guide part 3 in the main body 41. The frame member 49 is a sheet metal part and is provided along an extending direction of the main body 41. The frame member 49 and the guide part 3 are electrically coupled by a metal connection member 48. One end of the frame member 49 is bent toward the guide part 3 to form an extending terminal member 51. The terminal member 51 is a metal part and is screwed and fixed to a mounting part 52.

The mounting part 52 is a metal coupling member, and the static eliminator unit 50 is detachably attached to the support frame (not illustrated) in the housing 12 (FIG. 1). The mounting part 52 is provided at each of both ends of the static eliminator unit 50 in an extending direction. Since the support frame in the housing 12 is grounded, the main body 41 including the guide part 3 is electrically coupled to the GND potential.

In other words, the recording apparatus 100 further includes the mounting part 52 that detachably holds the static eliminator unit 50 including the guide part 3. The mounting part 52 includes a metal part, and the conveyance face 3a, which is a conductive region of the guide part 3, is grounded via the terminal member 51 serving as a metal part.

By making the static eliminator unit 50 detachable, maintainability is improved. Specifically, maintenance such as replacement of the static eliminator brush 42, collection of foreign matter in the storage corner, and cleaning of the first detection unit 55 and the second detection unit 56 is facilitated.

Returning to FIG. 4, the description continues.

As described above, the cleaning blade 43 is attached to the inner side of the side wall 41a of the main body 41. In a preferred example, the cleaning blade 43 is a blade made of conductive rubber, and is electrically coupled to the side wall 41a via a support portion. In other words, the cleaning blade 43 as a cleaning portion has conductivity and is held by the main body 41 formed integrally with the conveyance face 3a of the guide part 3 as the conductive region.

Since the cleaning blade 43 is also grounded, the blade is subjected to static electricity elimination and adhesion of a foreign matter such as paper dust can be restricted, so that the static eliminator brush 42 can be efficiently cleaned with a clean blade.

### Effect Verification

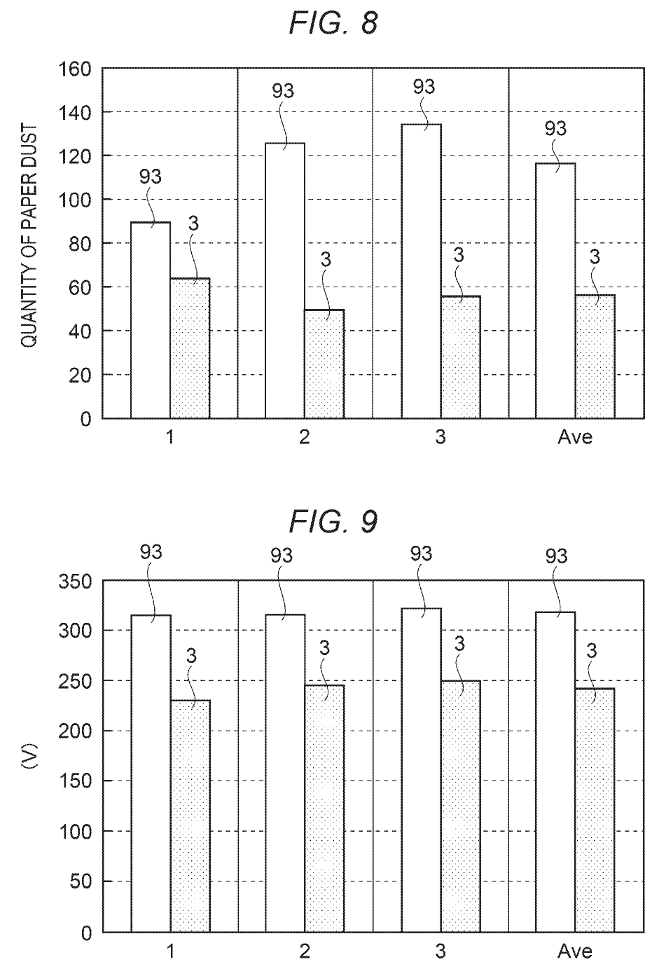

FIG. 8 is a graph illustrating measurement results about the quantity of adhered paper dust when the guide part is made conductive, in which a horizontal axis represents a test number and a vertical axis represents the quantity of paper dust.

The disclosers and the like set a standard resin guide part 93 that was not made conductive in the related art and the conductive guide part 3 described above in the recording apparatus 100, and performed an experiment of comparing and measuring the quantity of paper dust adhered to the nozzle surface 23a of the recording unit 22. In the experiment, the recording apparatus 100 in which the guide part 93 in the related art was set performed printing on 2000 sheets of paper as the medium 9, and then measured the quantity of paper dust. Next, the recording apparatus 100 in which the conductive guide part 3 was set performed printing on 2000 sheets of paper, and then measured the quantity of paper dust. This was taken as one set, and three sets of this experiment were performed.

As illustrated in FIG. 8, in the experimental result of the first set, the quantity of paper dust was 89 with the guide part 93 in the related art, and the quantity of paper dust was 63 with the conductive guide part 3.

In the experimental result of the second set, the quantity of paper dust was 125 with the guide part 93 in the related art, and the quantity of paper dust was 49 with the conductive guide part 3.

In the experimental result of the third set, the quantity of paper dust was 134 with the guide part 93 in the related art, and the quantity of paper dust was 55 with the conductive guide part 3.

In the average of the three experiments, the quantity of paper dust was 116 with the guide part 93 in the related art, and the quantity of paper dust was 55.7 with the conductive guide part 3. As described, it was confirmed that the quantity of paper dust adhered to the nozzle surface 23a of the recording unit 22 was reduced by half on average by making the guide part conductive.

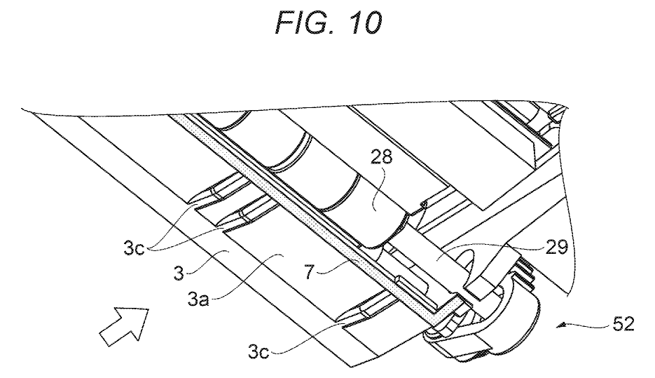

FIG. 9 is a graph illustrating measurement results about a paper surface potential when the guide part is made conductive, in which a horizontal axis represents a test number and a vertical axis represents a potential (V) of the paper surface.

Next, the standard resin guide part 93 that was not made conductive and the conductive guide part 3 were set in the recording apparatus 100, and an experiment of comparing and measuring a charge amount (V) on the surface of paper on the conveyance belt 17 immediately after passing through the guide part was performed.

As illustrated in FIG. 9, in the experimental result of the first set, the paper surface potential was 316 V with the guide part 93 in the related art, and the paper surface potential was 231 V with the conductive guide part 3.

In the experimental result of the second set, the paper surface potential was 316 V with the guide part 93 in the related art, and the paper surface potential was 245 V with the conductive guide part 3.

In the experimental result of the third set, the paper surface potential was 322 V with the guide part 93 in the related art, and the paper surface potential was 251 V with the conductive guide part 3.

In the average of the three experiments, the paper surface potential was 318 V with the guide part 93 in the related art, and the paper surface potential was 242 V with the conductive guide part 3. As described above, by making the guide part conductive, a decrease in the paper surface potential of about 76 V on average was confirmed.

According to the verification result of the discloser and the like, it is understood that when the paper surface potential decreases, the generation of paper dust is restricted and no large quantity of paper dust is scattered. Therefore, it is possible to reduce adhesion of foreign matters such as paper dust to the nozzle surface 23a.

As described above, according to the recording apparatus 100 of the embodiment, the following effects can be obtained.

The recording apparatus 100 includes the recording unit 22 that performs recording by ejecting a liquid onto the recording surface 9a of the medium 9, the conveyance belt 17 as a medium support portion that supports the medium 9 at a position facing the recording unit 22, and the guide part 3 that faces the recording surface 9a and guides the medium 9 to the conveyance belt 17. The guide part 3 has a conductive region having conductivity.

In a preferred example, since the guide part 3 is made of a conductive resin having conductivity, the protrusion 3b and the conveyance face 3a are conductive regions. Since the guide part 3 facing the recording surface 9a of the medium 9 has a conductive region, static elimination can be performed on the recording surface 9a. Accordingly, a foreign matter such as paper dust scattered from the recording surface 9a is scattered in a static-free state, so that the foreign matter is less likely to be attracted to the recording unit 22, and the scattering amount is reduced. Therefore, it is possible to restrict adhesion of the foreign matter to the nozzle surface 23a of the recording unit 22, which leads to improvement in recording accuracy and restriction of nozzle clogging.

Furthermore, since only the guide part 3 is made conductive, it is not necessary to add a new configuration, and it is possible to avoid an increase in the size of the apparatus and reduce the cost. In other words, it is not necessary to provide a dedicated paper dust capturing mechanism as in the related art, and adhesion of a foreign matter can be restricted with a simple configuration.

Therefore, it is possible to provide the recording apparatus 100 capable of restricting adhesion of a foreign matter with a simple configuration.

In the guide part 3, the conveyance face 3a facing the medium 9 is a conductive region.

According to this, since the conveyance face 3a facing the medium 9 is a conductive region, it is possible to increase a region where static elimination can be performed by contact with the medium 9, and it is possible to effectively perform static elimination.

The guide part 3 includes the conveyance face 3a facing the medium 9 and the protrusions 3b protruding from the conveyance face 3a toward the medium 9.

According to this, by providing the protrusions 3b, the contact area with the medium 9 can be reduced, the sliding load can be reduced, and the generation of static electricity due to friction can be restricted. In addition, since the protrusions 3b that easily come into contact with the medium 9 are conductive regions, it is possible to effectively perform static elimination.

The guide part 3 faces the conveyance belt 17.

Although static electricity due to friction is likely to be generated by the medium 9 coming into contact with the guide part 3 when the medium 9 rushes toward the conveyance belt 17, since the guide part 3 has a charging region, it is possible to remove the generated static electricity, and it is possible to more effectively restrict adhesion of a foreign matter.

When a length of the conveyance belt 17 in the conveyance direction is the same, a distance between the recording unit 22 and the guide part 3 is shorter in the configuration in which the conveyance belt 17 and the guide part 3 face each other than in a configuration in which the conveyance belt 17 and the guide part 3 do not face each other. Therefore, by performing static elimination with the guide part 3, it is possible to reduce the possibility that the medium 9 is recharged thereafter, and it is possible to more effectively restrict the adhesion of paper dust.

The conveyance belt 17 is an electrostatic attraction belt. The recording apparatus 100 includes the static eliminator unit 50 including the static eliminator brush 42 as a static eliminator portion that performs static elimination on the recording surface 9a of the medium 9 supported by the conveyance belt 17. The guide part 3 is provided integrally with the static eliminator unit 50, and at least a part of the conveyance face 3a as a conductive region is located upstream of the static eliminator brush 42 in the conveyance direction of the medium 9.

According to this, since the medium 9 is conveyed to the static eliminator brush 42 after the static elimination by the guide part 3, the medium 9 is also subjected to static elimination by the static eliminator brush 42, and thus the surface potential of the medium 9 immediately before is lowered, and the static elimination efficiency is improved. Accordingly, a potential difference from the conveyance belt 17 increases, and the medium 9 can be effectively attracted to the conveyance belt 17.

The static eliminator brush 42 as a static eliminator portion is displaceable between a static elimination position where static elimination is performed on the recording surface 9a of the medium 9 and a retracted position retracted from the static elimination position. The static eliminator unit 50 includes the cleaning blade 43 as a cleaning portion that cleans the static eliminator brush 42 during the displacement, and the cleaning blade 43 has conductivity and is held by the main body 41 formed integrally with the conveyance face 3a of the guide part 3 as a conductive region.

According to this, since the cleaning blade 43 is conductive and held in the conductive region, the cleaning blade 43 is also subjected to static elimination via the main body 41. By cleaning the static eliminator brush 42 with the static-free cleaning blade 43, a foreign matter adhered to the static eliminator brush 42 can be easily cleaned.

The upstream conveyance unit 15a that conveys the medium 9 to the guide part 3 is further provided, and the upstream conveyance unit 15a conveys the medium 9 in a curved shape with the recording surface 9a being convex.

According to this, in a configuration in which the upstream conveyance unit 15a conveys the medium 9 with the recording surface 9a convex outward, the downstream guide part 3 and the convex recording surface 9a easily rub each other and are easily charged, but static elimination can be performed by the conductive guide part 3. In other words, by bringing the recording surface 9a of the medium 9 into contact with the guide part 3, static elimination can be reliably performed.

The recording apparatus 100 further includes the mounting part 52 that detachably holds the static eliminator unit 50 including the guide part 3.

According to this, by making the static eliminator unit 50 detachable, the maintainability is improved. Specifically, maintenance such as replacement of the static eliminator brush 42, collection of foreign matter in the storage corner, and cleaning of the first detection unit 55 and the second detection unit 56 is facilitated.

At the time of maintenance of the recording apparatus of the related art in which the static eliminator unit that is not made conductive is mounted, it is also possible to obtain the same operation and effect as described above in the refurbished recording apparatus by mounting the static eliminator unit 50 of the embodiment.

The static eliminator unit 50 holds the first detection unit 55 and the second detection unit 56 as detection units that detect the medium 9.

According to this, the detection unit can also be replaced by replacing the static eliminator unit 50.

The mounting part 52 includes a metal part, and the conveyance face 3a, which is a conductive region of the guide part 3, is grounded via the terminal member 51 serving as the metal part.

According to this, the guide part 3 can be grounded via the mounting part 52.

When viewed in the conveyance direction of the medium 9, the guide part 3 overlaps the recording unit 22 that performs recording on the recording surface 9a.

According to this, since the guide part 3 and the recording unit 22 are disposed along the conveyance face 17a, it is possible to perform printing by the recording unit 22 after subjecting the medium 9 to static elimination by the upstream guide part 3.

The recording unit 22 is a line head capable of ejecting a liquid over the entire width of the medium 9 in the width direction intersecting the conveyance direction of the medium 9.

According to this, it is possible to restrict adhesion of a foreign matter to the line head.

### Second Embodiment

### Different Implementations of Conductive Region

FIG. 10 is a perspective view of a guide part according to a second embodiment, and corresponds to FIG. 5.

Although the conveyance face 3a including the protrusions 3b of the guide part 3 is described as a conductive region in the above-described embodiment, the present disclosure is not limited thereto, and a portion mainly in contact with the medium 9 may be selectively set as the conductive region. In the following description, the same portions as those in the above-described embodiment are denoted by the same reference signs, and a redundant description thereof will be omitted.

As illustrated in FIG. 10, the guide part 3 according to the embodiment is provided with a plurality of protrusions 3c. Each of the protrusions 3c is a conductive region and is, for example, a guide rib made of metal such as steel or stainless steel. The protrusions 3c are not limited to steel or stainless steel, and may be made of any metal having excellent conductivity and slidability. Alternatively, the protrusions 3c made of resin may be plated with metal. The number and shape of the protrusions 3c are the same as those of the protrusions 3b of the first embodiment except for the material.

A wiring 7 is provided along the following roller 28 at a downstream end portion of the guide part 3. The wiring 7 is, for example, a conductive wiring member such as an aluminum tape, and is electrically coupled to all the protrusions 3c. An end portion of the wiring 7 is electrically connected to the mounting part 52 and grounded. In other words, the guide part 3 includes the conveyance face 3a facing the medium 9 and the protrusions 3c protruding from the conveyance face 3a toward the medium 9, and each of the protrusions 3c is a conductive region.

As described above, according to the recording apparatus 100 of the embodiment, the following effects can be obtained in addition to the effects of the above-described embodiment.

The guide part 3 includes the conveyance face 3a facing the medium 9 and the protrusions 3c protruding from the conveyance face 3a toward the medium 9, and the protrusions 3c are conductive regions.

According to this, by using the protrusions 3c mainly in contact with the medium 9 as conductive regions, it is possible to reduce the contact area with the medium 9, reduce the sliding load, restrict the generation of static electricity due to friction, and effectively perform static elimination.

Therefore, it is possible to provide the recording apparatus 100 capable of restricting adhesion of a foreign matter with a simple configuration.

What is claimed is:

1. A recording apparatus comprising:
a recording unit configured to perform recording by ejecting a liquid onto a recording surface of a medium;
a medium support portion configured to support the medium at a position facing the recording unit; and
a guide part facing the recording surface of the medium and configured to guide the medium to the medium support portion, wherein
the guide part has a conductive region having conductivity.

2. The recording apparatus according to claim 1, wherein
a conveyance face of the guide part facing the medium is the conductive region.

3. The recording apparatus according to claim 1, wherein
the guide part includes a conveyance face facing the medium and a protrusion protruding from the conveyance face toward the medium, and
the protrusion is the conductive region.

4. The recording apparatus according to claim 1, wherein
the guide part faces the medium support portion.

5. The recording apparatus according to claim 4, comprising:
a static eliminator unit including a static eliminator portion configured to perform static elimination on the recording surface of the medium supported by the medium support portion, wherein
the medium support portion is an electrostatic attraction belt,
the guide part is provided integrally with the static eliminator unit, and
at least a part of the conductive region is located upstream of the static eliminator portion in a conveyance direction of the medium.

6. The recording apparatus according to claim 5, wherein
the static eliminator portion is displaceable between a static elimination position where static elimination is performed on the recording surface and a retracted position retracted from the static elimination position,
the static eliminator unit includes a cleaning portion configured to clean the static eliminator portion during the displacement, and
the cleaning portion has conductivity and is held in the conductive region.

7. The recording apparatus according to claim 1, further comprising:
an upstream conveyance unit configured to convey the medium to the guide part, wherein
the upstream conveyance unit conveys the medium in a curved shape with the recording surface being convex.

8. The recording apparatus according to claim 1, further comprising:
a mounting part configured to detachably hold the guide part.

9. The recording apparatus according to claim 5, further comprising;
a mounting part configured to detachably hold the static eliminator unit including the guide part.

10. The recording apparatus according to claim 9, wherein
the static eliminator unit holds a detection unit configured to detect the medium.

11. The recording apparatus according to claim 9, wherein
the mounting part includes a metal part, and
the conductive region is grounded via the metal part.

12. The recording apparatus according to claim 1, wherein
when viewed in a conveyance direction of the medium, the guide part overlaps the recording unit that performs recording on the recording surface.

13. The recording apparatus according to claim 1, wherein
the recording unit is a line head capable of ejecting the liquid over an entire width of the medium in a width direction intersecting a conveyance direction of the medium.
